(19) United States
(12) Patent Application Publication
(10) Pub. No.: US 2007/0179844 A1
(43) Pub. Date: Aug. 2, 2007

(54) System and method for insuring frequent traveler reward miles

(75) Inventors: Deanna E. Brannon, Jersey City, NJ (US); Jason T. Teichman, Ramsey, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Co., Inc., New York, NY (US)

(21) Appl. No.: 11/406,390

(22) Filed: Apr. 19, 2006

Related U.S. Application Data
(60) Provisional application No. 60/695,420, filed on Jul. 1, 2005.

(51) Int. Cl. G06Q 30/00

(52) U.S. Cl. 705/14

(57) ABSTRACT

Air miles insurance allows customers to protect the value of their reward miles when a covered airline ceases operation and those reward miles are not honored by another carrier, or if a covered airline continues to operate, but discontinues its reward program and the miles are not honored by another carrier. This air miles insurance can be associated with a particular transaction account company. The number of miles lost by an enrolled customer may be deposited into a mileage bank for the customer, which is then credited to the customer's transaction account when an airline ticket is purchased. The number of miles may alternatively be exchanged for points in the transaction account company's rewards program. The number of points awarded may be equal to the number of airline miles that the customer lost. The customer may then redeem the rewards points according to the rules of the rewards program.

### CROSS REFERENCE TO RELATED APPLICATIONS

This application claims the benefit of U.S. Provisional Patent Application No. 60/695,420, filed Jul. 1, 2005, which is incorporated herein by reference in its entirety.

### BACKGROUND OF THE INVENTION

1. Field of the Invention

The present invention relates to insurance, particularly frequent traveler reward insurance.

2. Background Art

Many travelers are members of one or more frequent traveler programs that reward airline miles. However, the airline industry has never before been in such a state of flux. Since the terrorist attacks on the United States on Sep. 11, 2001, the airline industry has been struggling, with the top ten carriers suffering losses of approximately $10 billion in 2004. The difficulties airlines currently face are unprecedented, with rising fuel costs, downward pressure on ticket prices, and over-supply plaguing the industry. As some major airlines are operating under the reorganization protections of the U.S. Bankruptcy Code, Title 11, Chapter 11, and as other airlines are contemplating possible Chapter 11 filings, the possibility that reward miles earned by a traveler may be lost is increasing. Therefore, a method and system of insuring reward miles is desirable.

### BRIEF SUMMARY OF THE INVENTION

Air miles insurance allows customers to protect the value of their reward miles in the event that a covered airline ceases operations, and those reward miles are not honored by another carrier; or if a covered airline continues to operate but discontinues its reward program, and the miles are not honored by another carrier. This air miles insurance can be associated with a particular transactional account company to streamline the redemption process.

In one embodiment, in the event of a covered loss, the same number of miles that the customer lost is deposited into the customer's mileage bank, which is created by the transactional account company. The number of miles deposited may be unlimited or may be capped at a number determined by the transactional account company. This mileage bank may be created specifically in the event of a loss. When the customer chooses to redeem the miles, the customer purchases an airline ticket to anywhere, on any airline, on a card associated with the transactional account company. This card may be, for example, a credit card. The customer then redeems miles from the customer's mileage bank, and a monetary credit is made to the customer's transaction account. The customer may receive, for example, $50 credit for every 3500 miles chosen to be redeemed.

In another embodiment, in the event of a covered loss, the customer is awarded points in the transactional account company's rewards program. The number of points awarded is based on the number of airline miles that the customer lost. The customer may redeem the points from the rewards program in any manner allowed by the rewards program.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a high-level flowchart of an example miles-for-credit redemption method.

FIGS. 2A and 2B together form a detailed flowchart of the example miles-for-credit redemption method of FIG. 1.

FIG. 3 is a high-level flowchart of an example miles-for-points redemption method.

FIG. 4 is a detailed flowchart of the example miles-for-points redemption method of FIG. 3.

FIG. 5 is a block diagram of an exemplary computer system useful for implementing the present invention.

The present invention will be described with reference to the accompanying drawings. The drawing in which an element first appears is typically indicated by the leftmost digit(s) in the corresponding reference number.

### DETAILED DESCRIPTION OF THE INVENTION

I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer,” “customer,” “participant,” “enrollee,” “cardmember,” and/or the plural form of these terms are used interchangeably throughout herein to refer to those persons or entities capable of accessing, using, being affected by and/or benefiting from the tool that the present invention provides for the insurance program described herein.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

1. Transaction Accounts and Instrument

A “transaction account” as used herein refers to an account associated with an open account or a closed account system (as described below) and is operated by a transactional account company, such as American Express Company of New York, N.Y. The transaction account may exist in a physical or non-physical embodiment. For example, a transaction account may be distributed in non-physical embodiments such as an account number, frequent traveler account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

2. Open Versus Closed Cards

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

3. Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments together totaling no more than ten dollars.

4. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

5. Account and Merchant Numbers

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember.

A merchant account number may be, for example, any number or alpha-numeric characters that identifies a particular merchant for purposes of card acceptance, account reconciliation, reporting and the like.

6. RFID and Transmission of Magnetic Stripe Data

It should be noted that the transfer of information in accordance with the present invention, may be done in a format recognizable by a merchant system or account issuer. In that regard, by way of example, the information may be transmitted from an RFID device to an RFID reader, or from the RFID reader to the merchant system in magnetic stripe or multi-track magnetic stripe format.

Because of the proliferation of devices using magnetic stripe format, the standards for coding information in magnetic stripe format were standardized by the International Organization for Standardization in ISO/IEC 7811-n (characteristics for identification cards) which are incorporated herein by reference. The ISO/IEC 7811 standards specify the conditions for conformance, physical characteristics for the card (warpage and surface distortions) and the magnetic stripe area (location, height and surface profile, roughness, adhesion, wear and resistance to chemicals), the signal amplitude performance characteristics of the magnetic stripe, the encoding specification including technique (MFM), angle of recording, bit density, flux transition spacing variation and signal amplitude, the data structure including track format, use of error correction techniques, user data capacity for ID-1, ID-2 and ID-3 size cards, and decoding techniques, and the location of encoded tracks.

Typically, magnetic stripe information is formatted in three tracks. Certain industry information must be maintained on certain portions of the tracks, while other portions of the tracks may have open data fields. The contents of each track and the formatting of the information provided to each track is controlled by the ISO/IEC 7811 standard. For example, the information must typically be encoded in binary. Track 1 is usually encoded with user information (i.e., name) in alphanumeric format. Track 2 is typically comprised of discretionary and nondiscretionary data fields. In one example, the nondiscretionary field may comprise 19 characters and the discretionary field may comprise 13 characters. Track 3 is typically reserved for financial transactions and includes enciphered versions of the user's personal identification number, country code, the amount of units authorized per cycle, subsidiary accounts, and restrictions.

As such, where information is provided in accordance with the present invention, it may be provided in magnetic stripe track format. For example, the counter values, authentication tags and encrypted identifiers, described herein, may be forwarded encoded in all or a portion of a data stream representing data encoded in, for example, track 2 or track 3 format.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

II. Air Miles Insurance

Air miles insurance allows customers to protect the value of their frequent traveler miles in the event that a covered provider ceases operations, and those frequent traveler miles are not honored by another provider. Air miles insurance also protects the value of a customer's frequent traveler miles in the event that a covered provider continues to operate, but discontinues its mileage reward program, and the miles are not honored by another provider. Although the present invention will be discussed in terms of airline miles, one of skill in the pertinent art(s) will recognize that the invention may also apply to other service provider rewards programs, such as a hotel rewards program, without departing from the spirit and scope of the present invention.

In an example embodiment, a transactional account company, such as American Express Company of New York, N.Y., can collaborate with an insurance provider to provide an air miles insurance program. The air miles insurance program may be a pure insurance product which may be filed on a state-by-state basis, and in one embodiment is not bundled with any non-insurance component. The air miles insurance policy may be structured in such a way that airlines can be added to or taken out of the program. A customer keeps the air miles insurance in force by payment of a premium while the provider's frequent traveler program is active. Miles or points resulting from a valid insurance claim may be pooled in the event that the customer elects joint coverage with another person or family member such as the customer's spouse or domestic partner, such that the insured frequent traveler miles are associated with more than one person. Miles or points resulting from a valid insurance claim may also be pooled if the customer files multiple claims due to losses with multiple covered providers.

The customer's air miles insurance policy may be associated with a transactional account held by the customer with the collaborating transactional account company. Customer accounts may be created and managed in multiple ways.

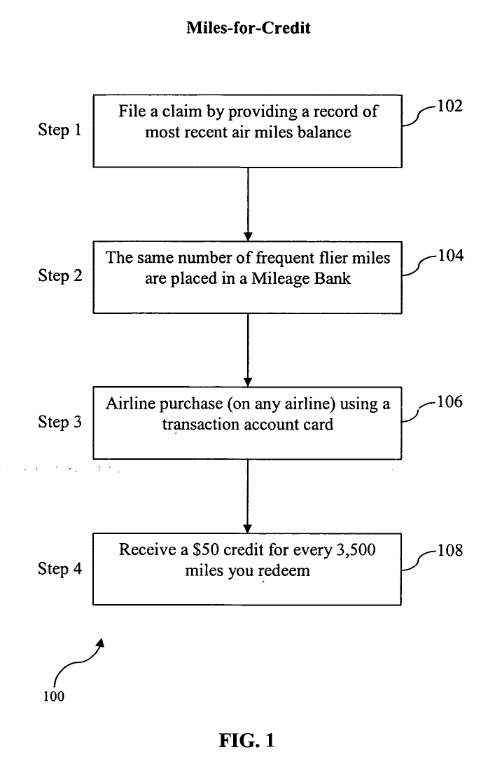

FIG. 1 is a high-level flowchart of an example method 100 according to a miles-for-credit embodiment of the present invention. In step 102, the customer files a claim under the customer's air miles insurance policy by providing a record of the customer's most recent miles balance. In step 104, if the claim is approved by the insurance servicing partner, the same number of miles that the customer lost from the frequent traveler program are deposited into the customer's mileage bank. The mileage bank may be created specifically in the event of a loss, and may include miles from one or more defunct frequent traveler programs. In step 106, when the customer redeems the miles in the mileage bank, the customer purchases an airline ticket to anywhere, on any airline, using the transactional account associated with the transactional account company. In step 108, miles are redeemed from the customer's mileage bank, and a corresponding credit is made to the customer's transactional account according to an exchange rate set forth in the miles insurance policy. For example, for every 3500 miles chosen to be redeemed, a $50 credit may be deposited in the customer's transactional account.

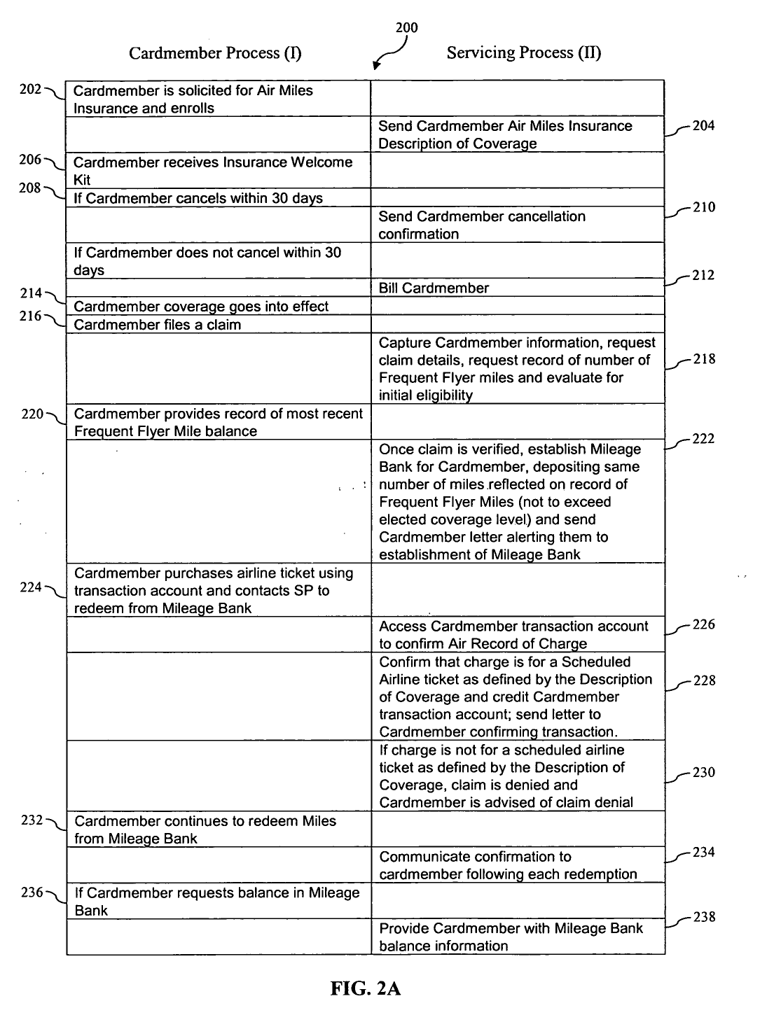

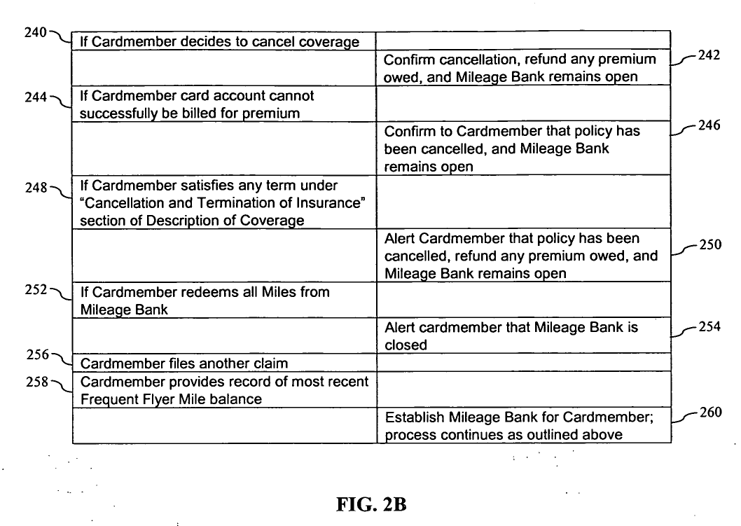

FIGS. 2A and 2B together illustrate a detailed flowchart of a miles-for-credit method 200, from enrollment to redemption. The flowchart differentiates between steps taken by a cardmember (“CM”), which are displayed in column (I), and steps taken by an insurance servicing partner (“SP”), which are displayed in column (II). One of skill in the pertinent art(s) will recognize that the steps in column (II), though described as being taken by a SP, may also be taken by the transactional account company associated with the insurance program or a servicing agent of either party.

In step 202, the CM receives a solicitation through one or more contact methods, such as, for example and without limitation, an emailed link to the program website, direct mail, telephone call, or newsletter. The customer responds to the solicitation by, for example, mailing in an enrollment form, calling a telephone number associated with the program, or accessing a web page associated with the program. CMs may elect various coverage levels, and have the option of paying monthly or annual premiums. Once the customer enrolls in the program, method 200 proceeds to step 204. In step 204, the SP processes the CM enrollment, and verifies the validity of the transaction account held by the CM with the associated transactional account company. If valid, the SP links the policy to the CM's transaction account. The SP may also send relevant documents to the CM, such as, without limitation, an air miles insurance welcome kit, a description of coverage, and any state-specific documents that apply to the CM's state of residence. Method 200 then proceeds to step 206.

In step 206, the CM receives the documents sent by the SP. The CM may be given a certain time period to review the policy and cancel with no penalties. This time period may be, for example, 30 days. Method 200 then proceeds to step 208, in which it is determined whether the CM cancels the policy within the given time period. If it is determined in step 208 that the CM does cancel the policy within a given time period, method 200 proceeds to step 210. In step 210, the SP sends a cancellation confirmation to the CM. If it is determined in step 208 that the CM does not cancel the policy within the given time period, method 200 proceeds to step 212.

In step 212, the SP bills the initial premium to the CM. The premium may be billed annually, or it may be split up into a given number of payments per year. The premium bill may be included in, for example, a statement for the transaction account associated with the insurance policy. CMs are insured for any covered loss that occurs during the period in which their premiums are paid. CMs benefit from continuing to pay their premiums, since they continue to receive coverage for other covered airlines in the program. However, unlike benefit programs that require the continued payment of membership fees in order to redeem a previously-earned benefit, there is no requirement for the air miles insurance policy that CMs continue to pay a premium in order to receive benefits that they have already earned (e.g., miles deposited in the mileage bank after a claim was submitted and approved).

If, in step 212, the attempt to bill the premium to the CM's transaction account is unsuccessful, then the SP may notify the CM that the premium could not be billed and coverage is not in effect. If, in step 212, the SP successfully bills the premium to the CM's transaction account, then method 200 proceeds to step 214. In step 214, the CM's coverage goes into effect.

In step 216, the CM contacts the SP to file a claim based on a covered event. The covered event may be, for example, cessation of an airline company with which the customer has a frequent traveler account, or cessation of the airline company's frequent traveler program. Method 200 then proceeds to step 218.

In step 218, the SP captures the CM's information. The SP may request additional details regarding the claim. The SP may also request a record which shows the number of frequent traveler miles amassed by the customer at or near the time of the covered event (e.g., a copy of the CM's most recent frequent traveler account statement). The SP may also evaluate the claim for initial eligibility by, for example, checking the effective coverage date of the policy and making sure that the customer lives in a state eligible for the policy. Method 200 then proceeds to step 220.

In step 220, the CM provides the SP with a record of the CM's most recent frequent traveler account balance, and method 200 proceeds to step 222. In step 222, the SP reviews the record submitted by the customer and confirms, to the extent possible, its validity. If validity of the record is confirmed, the SP establishes a mileage bank for the CM. The mileage bank may have a maximum mileage cap that is determined by the elected coverage level. The air miles insurance policy protects all of a customer's frequent traveler miles that fall under the customer's elected coverage level. If covered, no miles are forfeited regardless of whether the number of miles is sufficient to meet the minimum number of miles needed for a free airline ticket. Therefore, the SP deposits the same number of miles into the mileage bank that is reflected on the record of frequent traveler miles provided by the CM. The SP also notifies the CM of the establishment of the mileage bank. The mileage bank then remains open and available to the CM without requiring payment of any further premiums from the CM's transaction account, although the CM may continue paying premiums to protect themselves from the occurrence of subsequent covered events. Method 200 then proceeds to step 224.

In step 224, the CM purchases an airline ticket using the transaction account associated with the insurance policy. The ticket may be purchased using, for example, a transactional card linked to the CM's transaction account. The CM may purchase any airline ticket to any destination for travel on any dates. For example, typical fare restrictions such as a 21-day advance purchase or Saturday night stay-over may not be required. After the ticket has been purchased, the CM contacts the SP to redeem miles from the CM's mileage bank. The CM may indicate the number of miles to be redeemed. This allows the CM to use the miles to cover the entire cost of an airline ticket, or merely to offset the cost of an airline ticket. This is particularly useful when the number of miles deposited in the CM's mileage bank does not equal the minimum number of miles necessary to cover the entire cost of an airline ticket. Method 200 then proceeds to step 226.

In step 226, the SP accesses the CM's transaction account associated with the insurance policy to confirm the airline record of charge (“ROC”). The CM thus does not have to send in proof of an airline ticket purchase. If the charge is confirmed to be for a scheduled airline ticket as defined by the description of coverage, method 200 proceeds to step 228. In step 228, the mileage bank is debited by the number of miles requested by the CM, and a corresponding monetary credit is made to the CM's transaction account. Alternatively, the mileage bank is debited by the number of miles corresponding to the full cost of the ticket or the number of miles remaining in the mileage bank, whichever is less.

If the charge is not confirmed to be for a scheduled airline ticket as defined by the description of coverage, method 200 proceeds to step 230. In step 230, the claim is denied, and the CM is notified of the claim denial. The CM's transaction account is thus not credited.

In step 232, the CM continues to redeem miles from the CM's mileage bank in a manner similar to that described with respect to step 224. Method 200 then proceeds to step 234, in which the SP confirms the transaction after each successful redemption in a manner similar to that described with respect to steps 226-230.

Step 236 is an optional step initiated by the CM. In step 236, the CM contacts the SP to request notification of the balance of the mileage bank. If step 236 occurs, method 200 proceeds to step 238. In step 238, the SP notifies the CM of the mileage bank balance.

Step 240 is another optional step initiated by the CM. In step 240, the CM cancels coverage. If step 240 occurs, method 200 proceeds to step 242. In step 242, the SP sends notification of the cancellation to the CM and refunds a prorated amount of any premium already paid by the CM. Miles awarded from any covered event prior to the cancellation remain in the mileage bank, which remains open and available to the CM even after cancellation of the policy.

Step 244 is an optional step in which the CM transaction account cannot successfully be billed for the insurance premium. If step 244 occurs, method 200 proceeds to step 246. In step 246, the SP notifies the CM that the policy has been cancelled. Miles awarded from any covered event prior to the cancellation remain in the mileage bank, which remains open and available to the CM.

Step 248 is another optional step initiated by the CM. In step 248, the CM satisfies at least one of the terms under a section of the policy's description of coverage discussing reasons for cancellation and termination of insurance. Unlike step 240, in step 248, the CM does not notify the SP of the cancellation, but instead takes an action that results in cancellation. If step 248 occurs, method 200 proceeds to step 250. In step 250, the SP notifies the CM that the policy has been cancelled. Miles awarded from any covered event prior to the cancellation remain in the mileage bank, which remains open and available to the CM. Any premium that is owed is refunded to the CM's transactional account.

Step 252 is yet another optional step initiated by the CM. In step 252, the CM redeems all the miles from the mileage bank. If step 252 occurs, method 200 proceeds to step 254. In step 254, the SP notifies the CM that the mileage bank is closed.

Step 256 is still another optional step initiated by the CM. In step 256, the CM files another claim with the SP. If step 256 occurs, method 200 proceeds to step 258, in which the CM sends the SP a copy of the CM's most recent frequent traveler account statement for an additional covered frequent traveler account. Method 200 then proceeds to step 260, wherein the SP confirms the validity of the claim in a manner similar to that described with respect to steps 218-222, and deposits miles in a mileage bank. The mileage bank may be the same mileage bank already opened by a CM, or it may be a new mileage bank. The process then continues as described with respect to steps 224-254.

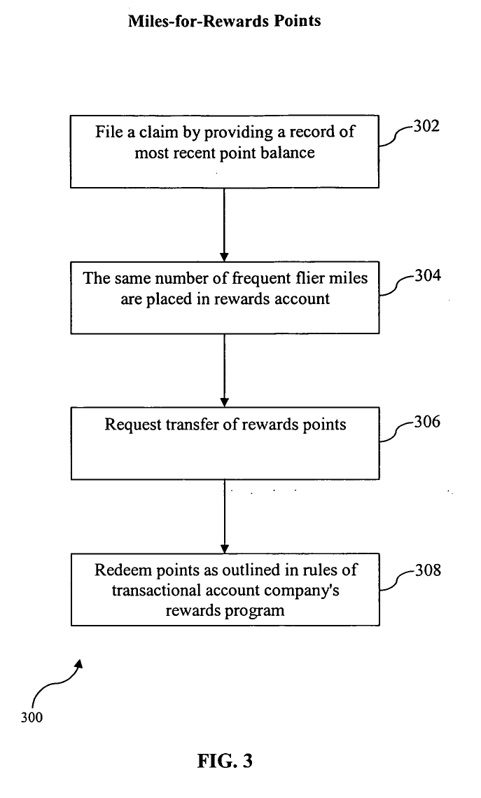

FIG. 3 is a high-level flowchart of an example method 300 according to a miles-for-points embodiment of the present invention. In step 302, the customer files a claim by providing a record of the customer's most recent miles balance. In step 304, in the event of a covered loss, the number of miles that the customer lost from the customer's frequent traveler program are converted into points for a rewards program associated with the customer's transaction account and deposited into the customer's rewards program account. The rewards program account may be created specifically in the event of a loss, or the rewards program account may be an existing rewards program account already held by the customer. The rewards program may be a proprietary program of the transactional account company associated with the customer's transaction account, and may offer a wide array of both travel and non-travel rewards. The rewards program may also be associated with a transaction card issued by the transactional account company, which is in turn associated with the customer's transaction account with the transactional account company. The number of points deposited into the customer's rewards program account is based on the number of airline miles that the customer lost. The customer may redeem the rewards points in adherence to the rules of the rewards program.

In step 306, when the customer chooses to redeem the points in the rewards account, the customer contacts the transactional account company to exchange points for a travel or non-travel award. In one example, the customer may request a transfer of points to a specific airline. In step 308, the customer contacts the airline to redeem the points. As with method 100, the steps of method 300 do not have to be performed in the order described.

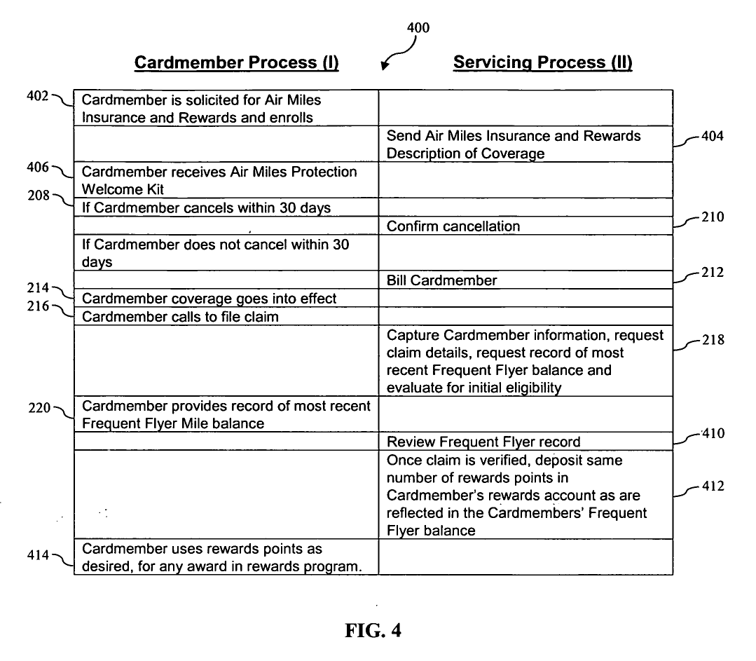

FIG. 4 illustrates a detailed flowchart of a miles-for-points method 400, from enrollment to redemption. In step 402, the CM receives solicitation through one or more contact methods, such as, for example and without limitation, an emailed link to the program website, direct mail, telephone call, or newsletter. The customer responds to the solicitation by, for example, mailing in an enrollment form, calling a telephone number associated with the program, or accessing a web page associated with the program. CMs may elect various coverage levels, and have the option of paying monthly or annual premiums. Once the customer enrolls in the program, method 400 proceeds to step 404.

In step 404, the SP processes the CM enrollment, and verifies the validity of the transaction account held by the CM with the associated transactional account company. If valid, instead of linking the insurance policy directly to the CM's transaction account as in method 200, the SP links the insurance policy to a rewards program account associated with the CM's transaction account. The SP may also send relevant documents to the CM, such as, without limitation, an air miles insurance welcome kit, a description of coverage, and any state-specific documents that apply to the CM's state of residence. Method 400 then proceeds to step 406.

In step 406, the CM receives the documents sent by the SP. The CM may be given a certain time period to review the policy and cancel with no penalties. This time period may be, for example, 30 days.

Steps 208 through 220 in method 400 are similar to the corresponding steps in method 200. After step 220, method 400 proceeds to step 410.

In step 410, the SP reviews the statement and confirms, to the extent possible, the validity of the frequent traveler account information submitted by the customer. If validity is confirmed, method 400 proceeds to step 412.

In step 412, after the claim submitted by the CM has been verified, the SP deposits a number of rewards points in the CM's rewards program account corresponding to the number of frequent traveler miles reflected on the CM's submitted frequent traveler account record. For example, the SP may deposit one rewards point for each frequent traveler mile submitted. Method 400 then proceeds to step 414.

In step 414, the customer redeems points from the customer's rewards program account according to the rules of the rewards program. For example, the customer may request that an appropriate number of rewards points be transmitted to a specific airline company for purchase of an airline ticket or to offset the cost of an airline ticket. In another example, the customer may use the rewards points for purchase of non-travel related goods and/or services.

III. Example Implementations

The present invention (e.g., the process described with respect to FIGS. 1-4 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

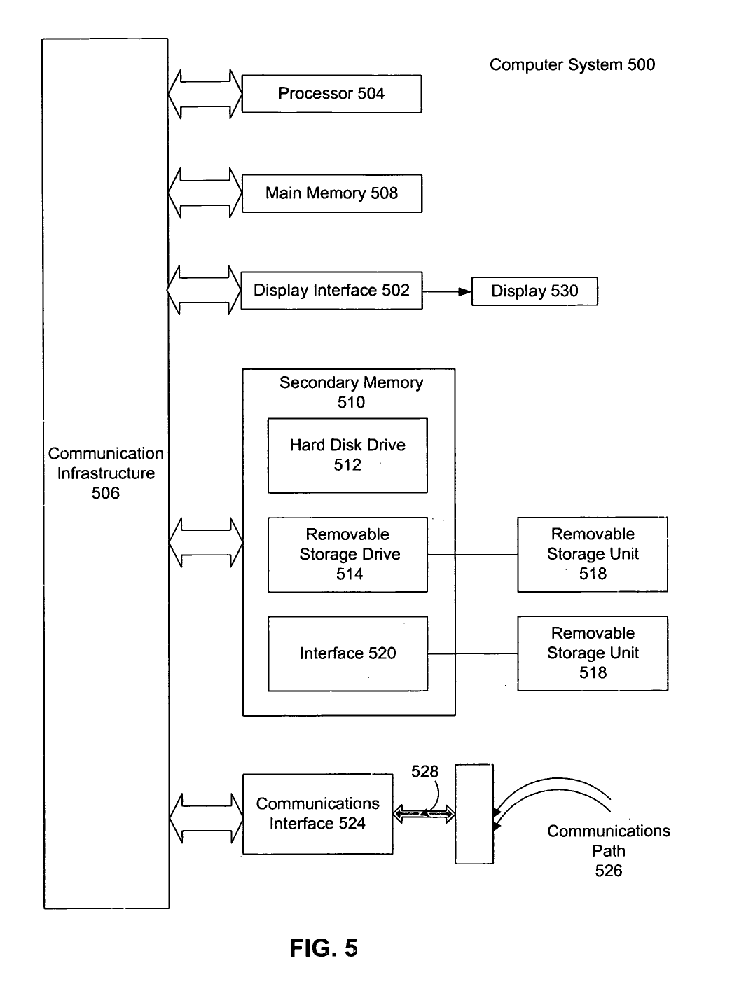

In fact, in one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 518 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 518 and interfaces 520, which allow software and data to be transferred from the removable storage unit 518 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 514, a hard disk installed in hard disk drive 512, and signals 528. These computer program products provide software to computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### IV. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of redeeming insured frequent traveler miles, comprising:
converting insured frequent traveler miles to rewards points when an event covered by a miles insurance policy occurs;
depositing the rewards points in a rewards program account associated with a customer transaction account; and
allowing redemption of at least a portion of the rewards points as payment for all or part of any type of goods or services purchase, without requiring payment of a premium after the occurrence of the covered event.

2. The method of claim 1, wherein the event includes at least one of cessation of service by an airline associated with the frequent traveler miles or discontinuance of a frequent traveler program associated with the frequent traveler miles.

3. The method of claim 1, wherein the insured frequent traveler miles are associated with more than one frequent traveler program.

4. The method of claim 1, wherein the insured frequent traveler miles are associated with more than one person.

5. The method of claim 1, further comprising insuring the frequent traveler miles of the customer according to the miles insurance policy.

6. The method of claim 1, further comprising:
converting additional insured frequent traveler miles to additional rewards points when another event covered by the miles insurance policy occurs; and
depositing the additional rewards points in the rewards program account.

7. A method of redeeming insured frequent traveler miles, comprising:
insuring frequent traveler miles according to a miles insurance policy;
depositing the frequent traveler miles into a customer mileage bank associated with a transaction account of the customer when an event covered by the miles insurance policy occurs;
verifying a travel-related record of charge in the transaction account of the customer upon receipt of a claim by the customer;
debiting the customer mileage bank by the number of miles to be used by the record of charge; and
crediting the transaction account of the customer with an amount of monetary funds corresponding to the number of miles used according to an exchange rate determined by the miles insurance policy.

8. The method of claim 7, wherein the event includes at least one of cessation of service by an airline associated with the frequent traveler miles or discontinuance of a frequent traveler program associated with the frequent traveler miles.

9. The method of claim 7, wherein the crediting step comprises crediting the transaction account of the customer without requiring payment of a premium after the occurrence of the covered event.

10. The method of claim 7, wherein the frequent traveler miles in the mileage bank are deposited from more than one frequent traveler program.

11. The method of claim 7, wherein the frequent traveler miles in the mileage bank are associated with more than one person.

12. The method of claim 7, further comprising:
depositing additional frequent traveler miles into the mileage bank when another event covered by the miles insurance policy occurs.

13. A system for redeeming insured frequent traveler miles, comprising:
a processor; and
a memory in communication with the processor for storing a plurality of processing instructions for directing the processor to:
convert insured frequent traveler miles to rewards points when an event covered by a miles insurance policy occurs;
deposit the rewards points in a rewards program account associated with a customer transaction account; and
allow redemption of at least a portion of the rewards points as payment for all or part of any type of goods or services purchase, without requiring payment of a premium after the occurrence of the covered event.

14. The system of claim 13, wherein the event includes at least one of cessation of service by an airline associated with the frequent traveler miles or discontinuance of a frequent traveler program associated with the frequent traveler miles.

15. The system of claim 13, wherein the insured frequent traveler miles are associated with more than one frequent traveler program.

16. The system of claim 13, wherein the insured frequent traveler miles are associated with more than one person.

17. The system of claim 13, wherein the plurality of processing instructions are further configured to direct the processor to:
convert additional insured frequent traveler miles to additional rewards points when another event covered by the miles insurance policy occurs; and
deposit the additional rewards points in the rewards program account.

18. A system for redeeming insured frequent traveler miles, comprising:
a processor; and
a memory in communication with the processor, the memory for storing a plurality of processing instructions for directing the processor to:
insure frequent traveler miles according to a miles insurance policy;
deposit the frequent traveler miles into a customer mileage bank associated with a transaction account of the customer when an event covered by the miles insurance policy occurs;
verify a travel-related record of charge in the transaction account of the customer upon receipt of a claim by the customer;
debit the customer mileage bank by the number of miles to be used by the record of charge; and
credit the transaction account of the customer with an amount of monetary funds corresponding to the number of miles used according to an exchange rate determined by the miles insurance policy.

19. The system of claim 18, wherein the event includes at least one of cessation of service by an airline associated with the frequent traveler miles or discontinuance of a frequent traveler program associated with the frequent traveler miles.

20. The system of claim 18, wherein the instructions for directing the processor to credit the transaction account of the customer comprise instructions for directing the processor to credit the transaction account of the customer without requiring payment of a premium after the occurrence of the covered event.

21. The system of claim 18, wherein the frequent traveler miles in the mileage bank are deposited from more than one frequent traveler program.

22. The system of claim 18, wherein the frequent traveler miles in the mileage bank are associated with more than one person.

23. The system of claim 18, wherein the plurality of processing instructions further include processing instructions for directing the processor to deposit additional frequent traveler miles into the mileage bank when another even covered by the miles insurance policy occurs.
